(19) United States
(12) Patent Application Publication
(10) Pub. No.: US 2023/0142131 A1
(43) Pub. Date: May 11, 2023

(54) ACTIVE LEARNING CLASSIFIER ENGINE USING BETA APPROXIMATION

(71) Applicant: SAMSUNG SDS AMERICA, INC., San Jose, CA (US)

(72) Inventor: Jae Oh WOO, Fremont, CA (US)

(73) Assignee: SAMSUNG SDS AMERICA, INC., San Jose, CA (US)

(21) Appl. No.: 17/826,928

(22) Filed: May 27, 2022

Related U.S. Application Data
(60) Provisional application No. 63/276,198, filed on Nov. 5, 2021.

(51) Int. Cl. G06N 3/08

(52) U.S. Cl. CPC G06N 3/08

(57) ABSTRACT

An active learning classifier engine is provided to reduce consumption of computer resources in acquiring data points for training of a model and then classifying data. The active learning classifier engine uses an acquisition function under a Bayesian active learning framework for acquiring the data points (“BABA”) from unlabeled training data. The acquisition function captures mutual information between the model parameters and the predictive outputs of the unlabeled training data and acquires useful unlabeled training data points which reduce classification errors of the model when classifying previously-unseen data by more properly and quickly placing decision boundaries used in the classification of the previously-unseen data.

### CROSS REFERENCE TO RELATED APPLICATION(S)

This application claims benefit of priority to U.S. Provisional Application No. 63/276,198 filed on Nov. 5, 2021, the contents of which are hereby incorporated by reference.

### FIELD

This application is in the field of active-learning artificial intelligence (AI).

### BACKGROUND

In modern machine learning, as the dataset size increases for training a complex model like detection and segmentation, labeling data by humans becomes expensive. A need exists to design a systematic way to prioritize the labeling dataset to save cost. This labeling prioritization process is called active learning. The active learning problem is well-aligned with a subset selection problem that can find the most efficient but minimal subset from the training data pool. The difference is that active learning is typically an iterative process where a model is trained and a collection of data points is selected to be labelled from an unlabeled data pool.

### SUMMARY

Standard deep learning models do not capture model uncertainty correctly. The simple predictive probabilities are usually erroneously described as model confidence. So there is a risk that a model can be misdirecting its outputs with high confidence. If a trained classifier is used before training is complete, a probability of wrong classification results occurs. If a trained classifier is trained for a long time to improve the statistics of the classification results, more computing power is needed in training.

Embodiments disclosed herein provide a new way to identify data used for training in order to reduce training time and obtain good statistics in classification results. This is an improvement in computer technology, as a computer is used for the training and a computer is used for the classification. The overall computer performance is improved by reducing the computations needed by the computer in training a model in order to obtain an accurate classification output from the computer using the model for classification of data.

Embodiments extend and improve recent advances in the Bayesian deep learning regime. Embodiments generalize the notion of the joint entropy between model parameters and the predictive outputs by applying a point process type entropy. By approximating the marginal probability distributions using Beta distributions, embodiments then derive an explicit formula of the upper bound of the joint entropy by estimating Beta parameters from Bayesian deep learning models. Then embodiments empirically demonstrate the improved performance of the proposed measure over the CIFAR-10, CIFAR-100, and Caltech-256 datasets compared to previous approaches.

Embodiments of the application thus speed training compared to other approaches. The improvement results in fewer training epochs and less computational effort consumed in training. The speed-up leads to an improved computer in which a classifier is trained and applied. This computer is referred to as an active learning classifier engine.

Provided herein is an active learning classifier engine for classifying an observation under a label using machine learning, the active learning classifier engine comprising one or more processors executing instructions from one or more memories to implement: a model builder engine configured to operate on a data set D_{training} and Dₚₒₒₗ and consult an oracle to produce a model after-convergence Φ and a classification engine configured to use the model after-convergence Φ to act on the observation to produce the label, wherein the model builder engine is configured to: identify, based on an entropy measure and an information measure, a training value x* for which a model-in-training Φ provides low information according to the entropy measure and the training value x* probably has some information about a correct classification Y* for x* according to the information measure, provide x* to the oracle to obtain Y*, and update the model-in-training with Y* to obtain the model after-convergence 1, thereby reducing a training time of the active learning classifier engine to obtain the label.

In some embodiments, the model builder engine is further configured to identify, based on the entropy measure and the information measure, the training value x* for which the model-in-training Φ provides first information below a first bit threshold according to the entropy measure and the training value x* is associated with second information above a second bit threshold about the correct classification Y* for x* according to the information measure.

In some embodiments, the first bit threshold is 0.1 bits precision per a ranked unlabeled data point and the second bit threshold is 0.1 bits per the ranked unlabeled data point.

In some embodiments, the information measure is BALD.

In some embodiments, the entropy measure is expressed as the following equation in which i ranges over a simplex of C classes, Pᵢ is an estimated probability of assigning a data point x to a class i, f(Pᵢ) is a density function and E_{P}_{ᵢ} is an expectation with respect to Pᵢ treated as a random variable: MJEnt[x]=−ΣᵢE_{P}_{ᵢ}[Pᵢ log(Pᵢf(Pᵢ))].

In some embodiments, f(Pᵢ) is a Beta distribution.

In some embodiments, the model builder engine is further configured to identify the training value x* for which the model-in-training provides approximately zero information value and x* has some information about the correct classification, Y, and such data x* has some correlation or compatibility with previously-used training data.

In some embodiments, the information is BALD, the model builder engine is further configured to identify, based on the entropy measure MJEnt[x] and BALD, the training value x* for which the model-in-training provides third information below a third bit threshold.

Also provided herein is another active learning classifier engine for classifying an observation under a label using machine learning, the active learning classifier engine comprising: one or more memories storing instructions; and one or more processors configured to execute the instructions to implement: a model builder engine configured to operate on a data set comprising D_{training} and Dₚₒₒₗ and consult an oracle to train a model-in-training and produce a model-after-convergence Φ, and a classification engine configured to use the model-after-convergence Φ to act on the observation to produce the label, wherein the model builder engine is further configured to: A) sample a first plurality of data points from D_{training}, B) for a first data point in the first plurality of data points: a) generate M dropout samples of estimated values y to form a plurality of estimated values y, wherein the estimated values y are samples of a domain of a simplex of classes, b) calculate a plurality of model statistics of the plurality of estimated values y, wherein the plurality of model statistics includes a first α and a first β for a first estimated value y corresponding to a first class in the simplex of classes, and c) calculate a first acquisition function measure for the first data point, C) repeat a) through c) for each data point in the first plurality of data points, thereby forming a plurality of acquisition function measures corresponding, respectively, to each data point in the first plurality of data points, D) rank the plurality of acquisition function measures, E) identify a top K data points of the first plurality of data points as x*, F) provide x* to the oracle to obtain Y*, and G) update the model-in-training with Y* to obtain the model-after-convergence, thereby reducing a training time of the active learning classifier engine to obtain the label.

Also provided herein is yet another active learning classifier for classifying an observation under a label using machine learning, the active learning classifier engine comprising one or more processors executing instructions from one or more memories to implement: a model builder engine configured to operate on a data set D_{training} and Dₚₒₒₗ for N epochs and produce a model after-convergence Φ wherein convergence corresponds to a classification accuracy measure exceeding an accuracy threshold; and a classification engine configured to use the model after-convergence Φ to act on the observation to produce the label, wherein the model builder engine is further configured to: identify a tentative decision boundary between at least two classes, evaluate uncertainty in a trial classification of a plurality of samples from Dₚₒₒₗ, wherein the plurality of samples are not in D_{training}, wherein the trial classification is based on a model-in-training, determine, based on the uncertainty, a plurality of information values respectively corresponding to the plurality of samples, select a second plurality of samples as a first number of top-ranked samples of the plurality of samples, wherein the second plurality of samples is approximately uniformly distributed along an extent of the tentative decision boundary and update the model-in-training based on the second plurality of samples.

In some embodiments, the model builder engine is further configured to obtain a plurality of labels for the second plurality of samples, respectively, before the model-in-training is updated.

In some embodiments, the model builder engine is further configured to obtain the plurality of labels from an oracle.

In some embodiments, the first number of top-ranked samples is 50. In some embodiments, the first number of top-ranked samples is 250. In some embodiments, the first number of top-ranked samples is more than about 50 and the first number of top-ranked samples is not more than about 1000. In some embodiments, the N epochs correspond to 100 epochs or less. In some embodiments, the accuracy threshold corresponds to 0.9 or better precision score on a benchmark data set. In some embodiments, the accuracy threshold corresponds to 0.9 or better recall score on a benchmark data set. In some embodiments, the benchmark data set is CIFAR-10, CIFAR-100, or Caltech-256.

### BRIEF DESCRIPTION OF THE DRAWINGS

The text and figures are provided solely as examples to aid the reader in understanding the invention. They are not intended and are not to be construed as limiting the scope of this invention in any manner. Although certain embodiments and examples have been provided, it will be apparent to those skilled in the art based on the disclosures herein that changes in the embodiments and examples shown may be made without departing from the scope of embodiments provided herein.

FIG. 1A illustrates an active learning classifier engine, according to some embodiments.

FIG. 1B illustrates further details of the active learning classifier engine, according to some embodiments.

FIG. 1C illustrates training a backbone and classification model using a model builder engine and then using the backbone and classification model at inference time, according to some embodiments.

FIGS. 2A, 2B, 2C, 2D, 2E, 2F, 2G, 2H, 2I and 2J illustrate example Beta distributions. Beta distributions are used in some embodiments.

FIG. 3 illustrates a formulation of a neural network Φ as an encoder-decoder communication network, according to some embodiments.

FIGS. 4A, 4B, and 4C illustrate a decision region for a 3 class moon data set in [symbol] ², according to some embodiments.

FIGS. 5A, 5B, and 5C illustrate a decision region for a 3 class moon data set in [symbol] ², according to a BALD acquisition measure.

FIGS. 6A, 6B, and 6C illustrate a decision region for a 3 class moon data set in [symbol] ², according to an Entropy acquisition measure.

FIGS. 7A, 7B, and 7C illustrate a decision region for a 3 class moon data set in [symbol] ², according to a MeanSD acquisition measure.

FIG. 8A illustrates a 3D plot of uncertainty measure of data over a domain, according to some embodiments.

FIGS. 8B, 8C, and 8D illustrate 3D plots of uncertainty measures of data over a domain for various acquisition functions as comparative examples.

FIG. 9 illustrates a correlation computation among uncertainty measures of various acquisition functions.

FIG. 10 illustrates exemplary hardware for implementation of the methods and devices disclosed herein.

### DETAILED DESCRIPTION

Embodiments provide an active learning framework in the Bayesian deep neural network model by leveraging the MC dropout (Monte Carlo dropout) method to approximate the Gaussian process. Predictive distributions generated from Bayesian deep learning models capture the uncertainty from the data and avoid overfitting.

The uncertainty measure under the Bayesian active learning framework provided herein may be referred to as “BABA” which means Beta Approximation for Bayesian Active Learning.

BABA applies MC dropouts at both training and inference time to generate and approximate each marginal distribution of the classes composing a simplex targeted by a classifier. The marginal distributions are approximated as Beta distributions. The Beta approximation is discretized over class and is continuous in domain and range for each marginal distribution. By using a point process entropy to represent both continuous and discrete domain random variables, a mutual information measure providing an acquisition function objective function is obtained.

A mutual information, I(·,·), between weights co in a model Φ(ω) and a classifier output Y(ω,x) may be referred to as Bayesian Active Learning by Disagreement (BALD), where x is data. That is, BALD=I(ω,Y(ω,x)).

In some embodiments, BABA is expressed as a ratio between BALD and a marginalized joint entropy, providing a closed-form expression.

The closed-form expression facilitates calculation. Also, BABA is parallelized by estimating two parameters on each marginalized Beta distribution.

BABA is a standalone measure without requiring relational computations with other data points.

BABA exhibits high sensitivity at decision boundaries because the two parameters of the approximated Beta distributions are sensitive near decision boundaries. Decision boundaries are critical in selecting the most beneficial next data point in active learning for updating the model under training. Thus BABA constantly provides fresh or well-diversified selections of data points for training along the decision boundary, unlike previously used methods such as BALD, entropy acquisition function and mean standard deviation (MeanSD) acquisition function.

BABA consistently outperforms previously used acquisition functions, which means that a BABA-based model training trains more quickly with less computational effort, thus improving the field of artificial intelligence model training. For continuous learning, applied classifications of an AI model are thus obtained with less computational effort. In some embodiments, the classifications are obtained more quickly in time. In some embodiments, the classification are obtained with higher accuracy in a limited computation capacity environment.

In practical scenarios, BABA consistently outperforms previously used active-learning methods including Bald, Entropy, MeanSD, CoreSet, CoreGCN, Uncertain GCN, and TA-VAAL. Comparisons have been computed as experimental results using the benchmark data sets of CIFAR-10, CIFAR-100 and Caltech-256.

This application discloses novel devices and methods to quantify the normalized mutual information between the model parameters and the predictive output of the data in the model. Especially for the joint entropy as a denominator of the normalized mutual information, it is not the same as a typical type of entropy like Shannon entropy or differential entropy. The measure used in embodiments involves a combination of discrete and continuous domain random structures, so the definition is closely related to the point process entropy. By approximating the marginals using Beta distributions, embodiments provide a useful expression for identifying data to be acquired from a pool of unlabeled training data. The expression includes an upper bound of the joint entropy by estimating Beta parameters from Bayesian deep learning models. The embodiments perform well training and then classifying data from the CIFAR-10, CIFAR-100 and Caltech-256 datasets. That is, the embodiments of this application outperform other approaches in classifying samples from the CIFAR-10, CIFAR-100 and Caltech-256 datasets.

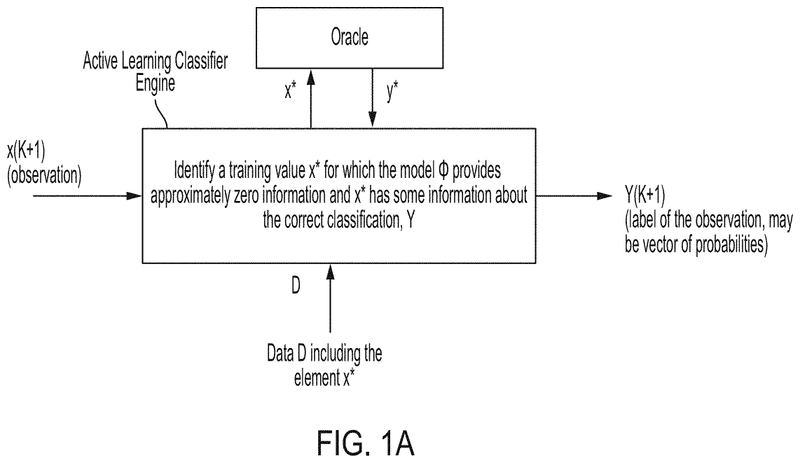

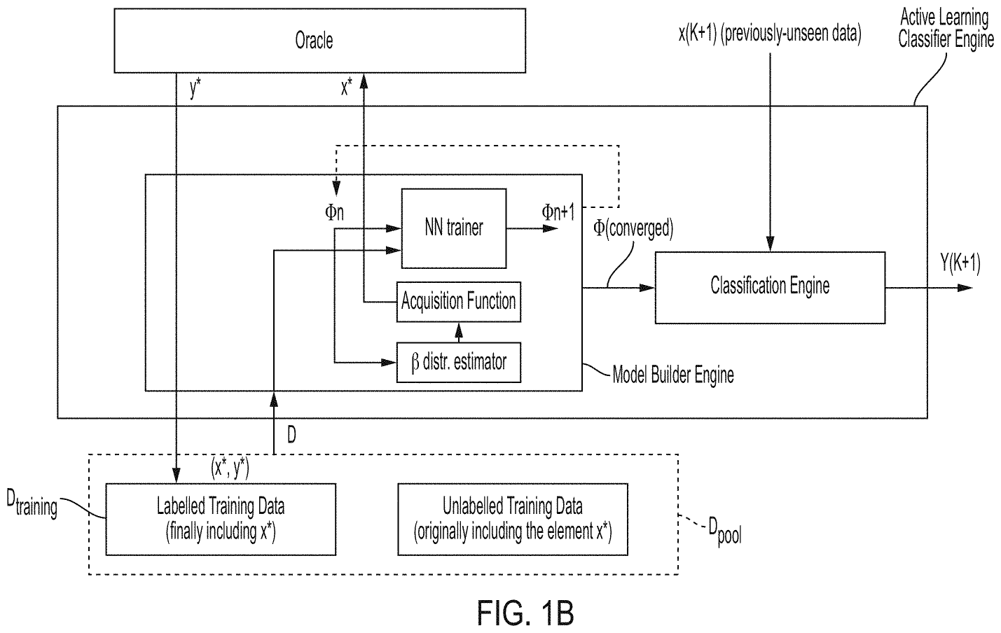

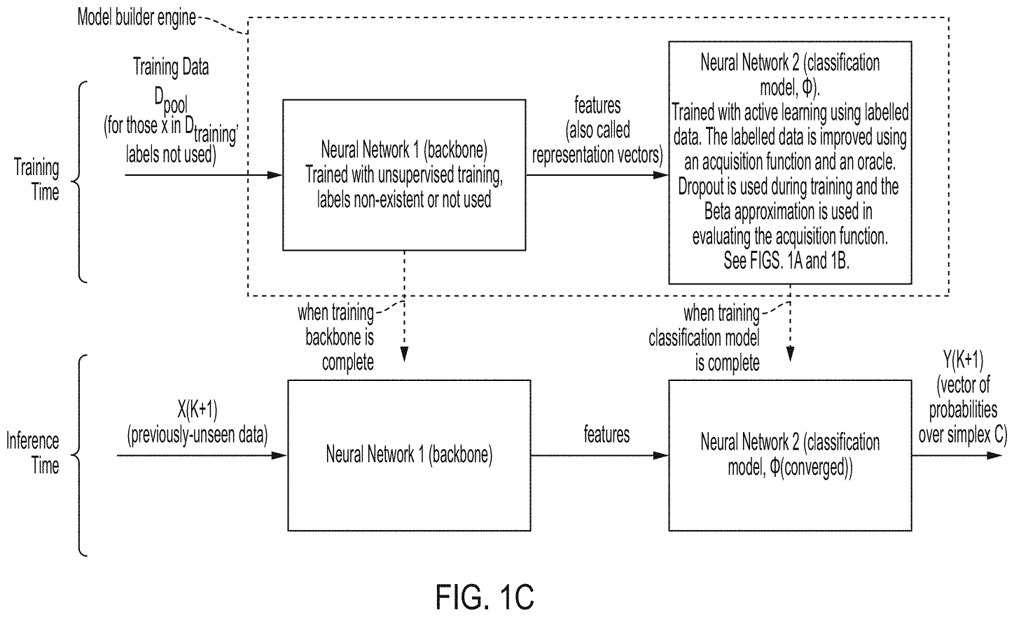

FIG. 1A illustrates an active learning classifier engine. The active learning classifier engine is trained on data D selectively using an oracle. The oracle is provided with an unlabeled element x* and asked for the proper label (y*). The active learning classifier engine identifies x* as an element of unlabeled training D for which the neural network model Φ provides low information x* has some information, in a theoretical sense, about the correct classification, y*.

In some embodiments, the points x* are selected by the acquisition function BABA (developed below) and the labels y* for the selected points x* are provided by a human (the oracle of FIGS. 1A and 1B).

After the model, Φ has been trained (referred to as Φ_{converged} in FIG. 1B), the engine operates on a data input x(K+1) to produce a label Y(K+1). X(K+1) is previously-unseen data. X(K+1) is not training data. Y(K+1) may be a vector of probabilities giving the probability that x(N+1) corresponds to each one of C different categories or classes.

FIG. 1B provides further details of the active learning classifier engine.

Data Dₚₒₒₗ includes unlabeled training data including the element x* and also labelled training data D_{training}.

The active learning classifier engine includes a model builder engine and a classification engine.

The model builder engine is trained for a time, for example K epochs, before the classification engine is used to classify the input x(K+1) to obtain the output Y(K+1).

Embodiments provided herein reduce the number of training epochs needed to obtain a high quality value of the output Y(K+1). Thus, the active learning classifier engine is an improvement in the field of computer technology.

The model builder engine includes a neural network (NN) trainer, an acquisition function and a Beta distribution estimator.

In active learning, an oracle is employed to selectively label some data from the collection of unlabeled data forming a subset of Dₚₒₒₗ.

The model Φ is trained using Dₚₒₒₗ. The training is broken into epochs. At each epoch new data is used. FIG. 1B illustrates Φ advancing from a first epoch to a second epoch with Φₙ as input to the NN trainer and Φₙ₊₁ as an output of the NN trainer. After K training epochs, the model Φ has converged and may be represented by the notation Φ_{converged}.

A Beta distribution estimator is used on some or all training epochs. The beta distribution estimator uses a current value of the model Φ to formulate a beta distribution modeling of the classes in Y. The beta distributions are used by an acquisition function to identify an unlabeled data element x* which is passed to the oracle. The precision with which x* is found reduces training time for model Φ and leads to an identification of the good quality output Y(K+1) in less time, thus improving the speed with which the active learning classifier engine can be trained and produce accurate outputs.

Further details of estimating the beta distributions and of the acquisition function are provided below. Also, the figures and tables provided herein demonstrate improved accuracy in obtaining the model Φ with limited references to the oracle.

An unlabeled dataset is indicated as Dₚₒₒₗ and the labelled training set D_{training} ⊆Dₚₒₒₗ in each active learning iteration. A superscript n, such as D_{training}⁽ⁿ⁾ is used if it's necessary to indicate the specific nth iteration step. Given D_{training} embodiments train a Bayesian deep neural network model Φ with model parameters ω˜p(ω). Then for a data point x given D_{training} the Bayesian deep neural network Φ produces the prediction probability:

Φ(x,ω):=(P₁(x,ω), . . . ,P_{C}(x,ω))∈Δ^{C} Eq. (1)

where Δ^{C} (p₁, . . . , p_{C}):p₁+ . . . +p_{C}=1, pᵢ≥0 for each i and C is the number of classes. For the final class output Y, it is assumed to be a multinoulli distribution (or categorical distribution):

$$Y ( x , ω ) := \{ \begin{matrix}1 & with probability & {P}_{1} ( x , ω ) \\ ⋮ & ⋮ & ⋮ \\ C & with probability & {P}_{C} ( x , ω )\end{matrix} \qquad Eq . ( 2 )$$

For the sake of brevity, embodiments sometimes omit x or co by writing Φ(ω), Pᵢ(ω),Y(ω) or Φ, Pᵢ, Y unless embodiments need further clarifications on each data point x. Under this formulation, the oracle (active learning algorithm) selects a subset of data points to add to the next training set, i.e. at (n+1)th iteration, the training set is determined by

D_{training}⁽ⁿ⁺¹⁾=D_{training}⁽ⁿ⁾∪{Next batch selected by Oracle}.

Once the next batch is selected, the selected batch will be labelled. This means that the ground truth label information of the selected data is added in training set D_{training}⁽ⁿ⁺¹⁾ in the next round. Then the goal in active learning is to minimize the number of oracle queries until it reaches a certain level of prediction accuracy.

FIG. 1C illustrates training a backbone and classification model using a model builder engine and then using the backbone and classification model at inference time. The backbone is labelled neural network 1 in FIG. 1C and the classification model, Φ, is referred to as neural network 2. The backbone is trained with unsupervised learning. That is, data from Dₚₒₒₗ is used to train the backbone. For those data elements of D_pool which are associated with labels (the set D_{training} of FIG. 1B), the labels are not used to train the backbone.

The backbone and the classification model Φ are trained by the model builder engine. The classification model Φ is trained with active learning using the labelled data contained in D_{training}. The labelled data is improved using an acquisition function and an oracle, as shown in FIGS. 1A and 1B.

When training is complete, the backbone and classification model Φ are used at inference time to operate on input data, for example, X(K+1), to produce a classification Y(K+1). Y(K+1) may be a vector of probabilities over the simplex C. The simplex C is the set of classes to which X is mapped. For example, for CIFAR-10, C is the set {airplanes, cars, birds, cats, deer, dogs, frogs, horses, ships, trucks}.

The backbone may be trained and then fixed. That is, the classification model may be trained after the backbone is trained. In Tables 1 and 3 discussed further below, the backbone has been trained and is no longer updated during the experiment. For Table 2, the backbone and the classification model continue training together until training is complete for both.

Acquisition Functions

In this section, embodiments list up well-known acquisition functions to obtain benchmarks, then embodiments shall compare the performances with the proposed measure, BABA in Section 5.

Random. Rand[x]:=U(′) where U(·) is a uniform distribution which is independent to ω. Random acquisition function assigns a random uniform value on [0,1] to each data point.

Variational Ratio. Variational Ratio captures the uncertainty with respect to the maximal expected predictive probability among all classes.

Predictive Entropy. The Predictive Entropy is also referred to, when considering acquisition function methods, as simply “Entropy.” Predictive entropy is the Shannon entropy with respect to the expected predictive probability.

Mean standard deviation (MSD). Mean standard deviation captures the average of the standard deviations for each marginal distribution.

BALD (Bayesian active learning by disagreement).

CoreGCN defines a sequential Graph Convolution Network (GCN). Each image's feature from a pool of data represents a node in the graph and the edges encode their similarities. With a small number of randomly sampled images as seed labelled examples, parameters of the graph are trained to distinguish labelled vs unlabeled nodes by minimizing the binary cross-entropy loss.

UncertainGCN is based on the active learning method of uncertainty sampling which tracks the confidence scores of the designed graph nodes.

CoreSet defines the problem of active learning as core-set selection, which includes choosing set of points such that a model learned over the selected subset is competitive for the remaining data points.

TA-VAAL is task-aware variational adversarial active learning. TA-VAAL modifies task-agnostic variational adversarial active learning, that considered data distribution of both label and unlabeled pools, by relaxing task learning loss prediction to ranking loss prediction and by using ranking conditional generative adversarial network to embed normalized ranking loss information on VAAL.

In a multiple acquisition size setting, embodiments simply add the above acquisition functions for each data point xi:

AcqFunc[x₁, . . . ,xₙ]:=ΣAcqFun[xᵢ] Eq. (3)

Where the sum is from i=1 to i=n and AcqFunc is one of the five acquisition functions listed above {Rand, VarRatio, PredEntropy, MeanSTD and BALD}.

Along with the algorithms mentioned earlier, there are many other approaches to finding the next batch, especially in multiple acquisitions and mostly non-Bayesian scenario. e.g., Core-Set method, Variational adversarial active learning, Margin based adversarial active learning, point process-based active learning, and Wasserstein distance-based active learning. In the following, although embodiments propose and test the selection of the following labeling candidates in a multiple acquisition scenario to illustrate the performance of embodiments, the main scope of this paper is to propose a novel acquisition measure for developing a new computational framework by using Beta approximations. Embodiments also confirm that it outperforms the well-known family of acquisition functions in CIFAR-10, CIFAR-100 and Caltech-256 datasets.

Bayesian Deep Learning Model

Embodiments adopt the Bayesian neural network framework introduced in Gal et al. (“Deep bayesian active learning with image data,” published in International Conf. on Machine Learning, pages 118-3-1192, PMLR, 2017). The core idea in the Bayesian neural network is leveraging the dropout feature to generate a distribution of the predictive probability as an output. Dropout refers to dropping out units (hidden and visible) in a neural network. A probability determines which outputs of a layer are dropped out (dropout rate). Alternatively, the probability of retaining an output may be specified. A common value is 0.5 for retaining the output of each node in a hidden layer and a value close to 1.0, such as 0.8, for retaining outputs of the visible layer. The dropout technique is equivalent to an approximation to a particular Bayesian model such as a Gaussian process.

Beta Approximation

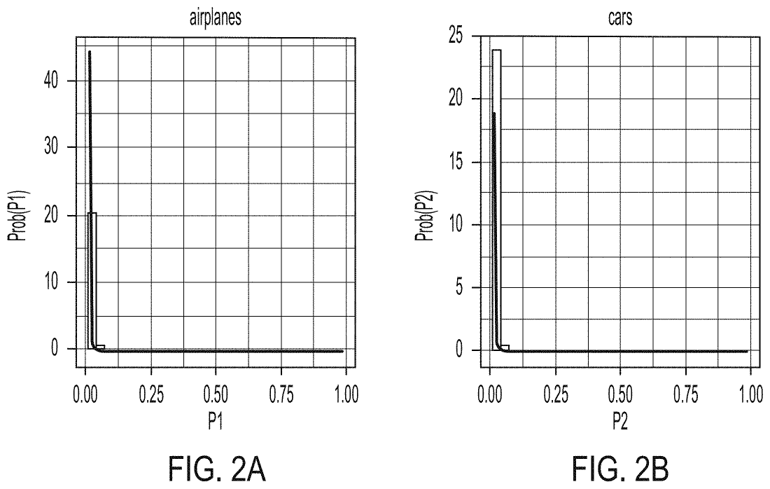

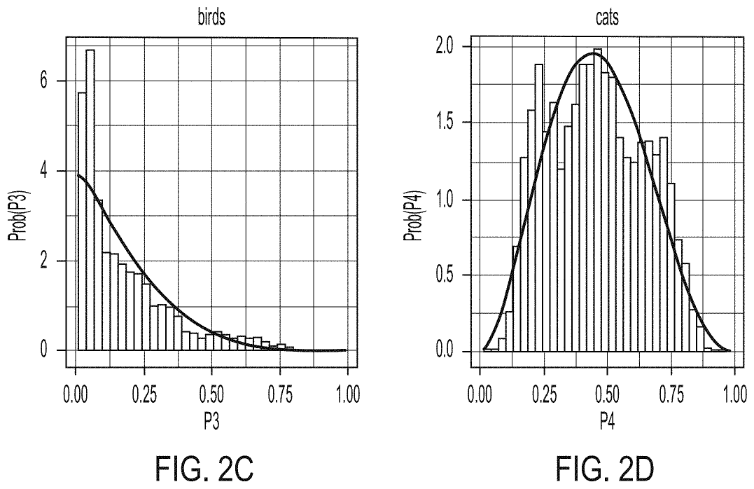

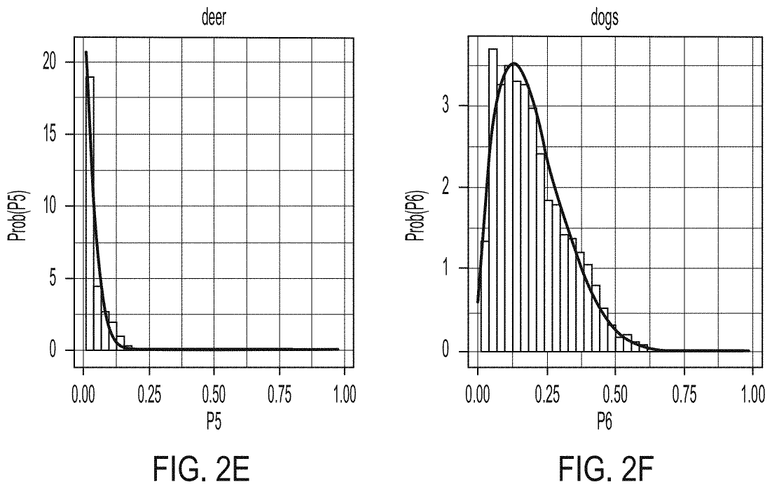

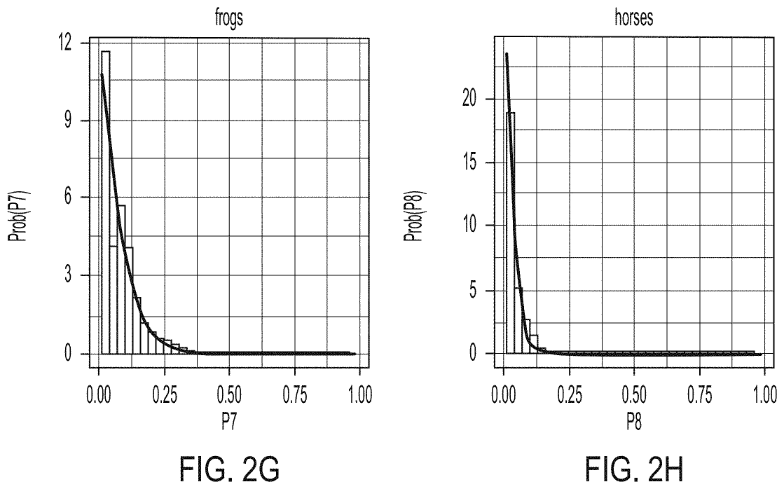

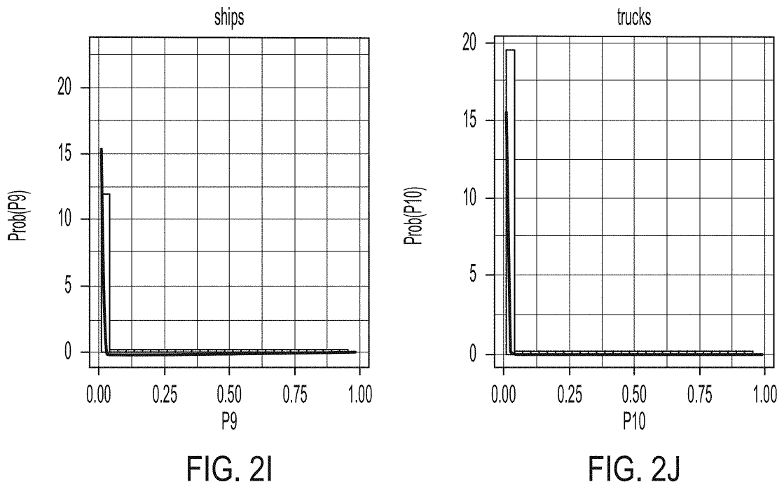

FIGS. 2A-2J illustrate an example Beta approximations for each marginal distribution after applying a softmax layer in the CIFAR-10 dataset. Softmax is a mathematical function that converts a vector of numbers into a vector of probabilities, where the probabilities of each value are proportional to the relative scale of each value in the vector. Each Beta distribution is estimated by calculating the sample mean and sample variance of the histogram generated by the Bayesian deep learning model.

In this section, embodiments consider a Bayesian neural network model Φ as a random measure, i.e., stochastic process parametrized by set D_{training} over the data set Dₚₒₒₗ. Given a data point x∈Dₚₒₒₗ, Φ(x,ω) produces a random probability distribution in a simplex Δ^{C}. This analogy has a close connection with the construction of random discrete distribution. Random measure construction has been developed in Bayesian nonparametrics, and it is known that Dirichlet probability having Beta marginals plays a central role in a construction of a random discrete distribution. This is a motivation of the Beta approximation provided herein.

The underlying Beta approximation process is justified as follows. A Dirichlet probability can be constructed through a collection of independent Gamma distributions. On the other hand, each marginal in Gaussian Process in the soft-max output having dependent components follows a log-normal distribution (before the normalization, but after the exponentiation in soft-max). Ignoring a dependency of components of log-normal distributions because of the shape similarity between a log-normal distribution and Gamma distribution, the construction of random probability from log-normal distributions produces an approximated Dirichlet distribution. Thus, the marginal distribution approximately follows the Beta distribution.

FIGS. 2A, 2B, 2C, 2D, 2E, 2F, 2G, 2H, 2I and 2J show examples of Beta approximations obtained from CIFAR-10 dataset. P₁, . . . , P₁₀ show each marginal distribution of the predictive probability of each digit. These figures demonstrate that the Beta approximation is a reasonable approximation.

In practice, the sample mean and sample variance for are estimated for each marginal, and the two parameters of the Beta distribution are estimated by Eq. (4) below.

Assume that P˜Beta(α,β).

If the mean of P is m and the variance of P is σ² then

$$α = \frac{{m}^{2} ( 1 - m )}{{σ}^{2}} - m and β = ( \frac{1}{m} - 1 ) α \qquad Eq . ( 4 )$$

Entropy and Mutual Information in Bayesian Neural Network

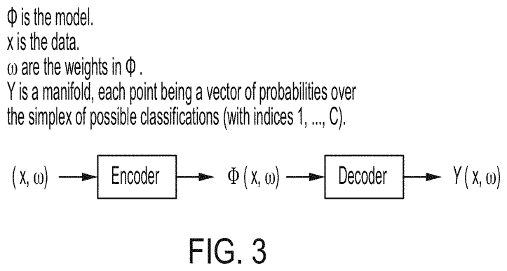

In this section, the Bayesian neural network is discussed from an information-theoretic perspective. The Bayesian neural network Φ is formulated as an encoder-decoder communication channel. The sender sends a message (x,ω) with a random key ω through the channel, then the receiver receives a message Y(x,ω). FIG. 3 illustrates a diagram in this communication process.

The following describes finding the mutual information between the input and the output of the channel related to estimate a capacity of the network communication channel. The mutual information is, in fact, one of the acquisition measures, (BALD).

BALD[x]:=I((x,ω),Y(x,ω))=I(ω,Y(x,ω)) Eq. (5)

where I(·) represents a mutual information between two quantities.

The following describes calculating the joint entropy of Φ(x,ω) and Y(x,ω), denoting by H_{J}(Φ(x,ω),Y(x,ω)). To calculate the joint entropy, note that Φ(x,ω) is on a continuous domain Δ^{C}, and Y(x,ω) is on a discrete domain [C]={1, . . . , C}. This means that the usual notions of Shannon entropy and differential entropy cannot be applied. However, disclosed herein is the notion of the point process entropy which can accommodate both continuous and discrete domain random structures. A Janossy density function of (Φ(x,ω),Y(x,ω)) on Δ^{C}×C is written as follows:

j(p₁, . . . ,p_{C},y=i)=pᵢf(p₁, . . . ,p_{C}) Eq. (6)

where f(·) is a density function of Φ(x,ω). Then the joint entropy of Φ(x,ω) and Y(x,ω) can be defined as:

H_{J}(Φ(x,ω),Y(x,ω))=−Σ∫j(p₁, . . . ,p_{C},y=i)log j(p₁, . . . ,p_{C},y=i)dp₁ . . . dp_{C} Eq. (7)

where the sum is from i=1 to i=C and the domain of the integral is Δ^{C}.

By plugging Eq. (6) into Eq. (7), the following identity is obtained.

H_{J}(Φ(x,ω),Y(x,ω))=H(Y(x,ω))+E_{Y}[h(Φ(x,ω)≡Y)] Eq. (8)

where E_{Y} is an expectation, H(·) represents the usual Shannon entropy, and h(·) represents the usual differential entropy. The dependency within the components is handled by approximating Φ(x,ω) to be Dirichlet distribution. By applying Jensen's inequality, a marginalized joint entropy being an upper bound of the joint entropy is as follows:

H_{J}(Φ(x,ω),Y(x,ω))≤−ΣᵢE_{P}_{ᵢ}[Pᵢ log(Pᵢf(Pᵢ))] Eq. (9)

where f(·) is a density function for each Pᵢ.

Assuming that each Pᵢ˜Beta(αᵢ,βᵢ) by applying the Beta approximation for each marginal.

The explicit formula of the Beta approximated upper joint entropy can be found as follows:

$$MJEnt [ x ] := - {\sum }_{i} {E}_{{P}_{i}} [ {P}_{i} log ( {P}_{i} f ( {P}_{i} ) ) ] = {\sum }_{i} ( {E}_{{P}_{i}} ) [ h ( {P}_{i}^{+} ) - log ( {EP}_{i} ) ] \qquad Eq . ( 10 )$$

where Pᵢ⁺ is the conjugate Beta posterior entropy of Pᵢ which follows Pᵢ⁺˜Beta(αᵢ+1,βᵢ) by applying the Beta approximation and where Σᵢ is the sum over index i.

The function h(Pᵢ⁺) can be calculated by the closed form entropy formula of the the Beta distribution as in Eq. 11.

h(Pᵢ⁺)=log B(αᵢ+1,βᵢ)−αᵢΨ(αᵢ+1)

−(βᵢ−1)Ψ(βᵢ)−(αᵢ+βᵢ−1)Ψ(αᵢ+βᵢ+1) Eq. (11)

where B(·,·) is the Beta function and Ψ(·) is the Digamma function.

The dropout-based Bayesian neural network training typically requires adding a dropout layer with ReLU activation for each convolutional or linear layer to approximate a Gaussian process. But this is a computationally costly process. Therefore, in some embodiments a simple last-layer dropout architecture is used to build a Bayesian neural network equipped with the Beta approximation described above (also see the BABA Pseudocode below). Similar to Laplace approximation applied at the last layer, some embodiments replace the last linear layer with a dropout applied and ReLU activated linear layer. In addition, after initializing the neural network at the initial step, embodiments re-train the Bayesian neural network on top of the previous model weights trained at the earlier iteration without re-initializing all weights of the model. This re-training scheme of the prior iteration is more aligned with the Bayesian perspective and assists the effect of the knowledge transfer as the active learning iterations progress.

BABA Uncertainty Measure

BABA is defined in Eq. (12) as a ratio between BALD and the Beta approximated upper joint entropy, MJEnt[x] when MJEnt[x] is greater or equal to zero and as the ratio between MJEnt[x] and BALD when MJEnt[x] is negative. In a practical application, if MJEnt[x] takes on a value of zero, BABA indicates that the point is very important.

$$BABA [ x ] := \frac{BALD [ x ]}{MJEnt [ x ]} if MJEnt [ x ] \geq 0 , and BABA [ x ] := \frac{MJEn t [ x ]}{BALD [ x ]} if MJEnt [ x ] < 0 \qquad Eq . ( 12 )$$

Computational Effort of BABA

At the same GPU environment, e.g. GTX 1080Ti with 11 Gb memory, with the acquisition size 20, the computational time for BABA is about 10-times faster than Batch-BALD. This computational cost varies from different GPU choices, especially depending on the GPU memory size, or the number of GPUs. BABA is sufficiently accurate to use as the acquisition function (a Batch BABA is not needed).

Rationale of BABA

BABA is developed as follows. BABA is a heuristic, not a mathematically-optimized formula.

MJEnt[x]=Σᵢ(EPᵢ)(hPᵢ⁺)+H(Y) Eq. (13)

In the right hand side (RHS) of Eq. (13), the first term, that is the term on the left within the RHS, is the posterior uncertainty. The term H(Y) is the entropy.

The posterior uncertainty is an expected posterior entropy assuming an observation of a positive sample of the class toward Pᵢ for each i without knowing the true class label. The posterior uncertainty is always non-positive, and is maximized (equals to zero) when each Pᵢ⁺ is Beta(1,1), i.e., uniformly distributed on [0,1]. So −∞<MJEnt[x]≤H(Y). The second term of the RHS of Eq. (13) can be written as two uncertainty terms as shown in Eq. (13).

H(Y)=1(ω,Y)+E_{ω}[H(Y|ω)] Eq. (14)

The first term on the RHS of Eq. (14) is the epistemic uncertainty and captures model uncertainty (as does BALD). The second term on the RHS of Eq. (14) is the aleatoric uncertainty and captures the data uncertainty. Thus, MJEnt[x] is a composition of three types of uncertainty values.

When MJEnt[x]→−∞, the posterior uncertainty dominates the value, and the model is very confident about its prediction. MJEnt[x]→H(Y), the posterior uncertainty goes to zero, so the model does not have much knowledge about its predictions the aleatoric uncertainty typically dominates. Also, when MJEnt[x]→0, substantial meaning is attached where near zero is a balanced point under some geometry when three uncertainties are entangled (as opposed to two extreme directions away from zero). The term MJEnt[x] is related to the Lyapunov exponent of the model as a dynamical system.

With respect to the Lyapunov exponent, MJEnt[x]>0 implies that those points are unstable (so incompatible) concerning the model's current status of the knowledge. So it is beneficial to gradually add those incompatible points to the next training to improve the model's decision knowledge. However, as an acquisition function which must make a choice among unlabeled points to pick one point for labelling, priority is given from less-incompatible points (near zero) first as it will not conflict too much with the current knowledge.

If the acquisition function adds incompatible points first without bridging the information gap, then there is a chance that the next training model could still be confused. So the functional form of BABA is an inverse of MJEnt[x] on the non-negative side (the BABA ratio of Eq. (12) greater than zero) to give the high priority near the zero value. Multiplying BALD improves the performance as the algorithm provided herein emphasizes the epistemic uncertainty more.

For the values of the BABA ratio (Eq. 12) which are less than zero (negative), embodiments give the second priority after the positive side of BABA. Then the algorithm implements the importance MJEnt[x] near-zero first since the near-zero region is under the stable zone but less compatible with the current knowledge. Therefore, the algorithm uses the reciprocal of the ratio in the positive case to achieve high BABA values.

To illustrate the behavior of BABA and its relationship with other uncertainty measures, embodiments train a Bayesian neural network with a 3-class moon dataset in R². Typical classified points in each moon-shape are marked with shaded circles. Then embodiments calculate each uncertainty measure for all fixed lattice points in the square domain by assuming that the unlabeled pool is highly regularized (or uniform). i.e., by evenly discretizing the domain, embodiments obtain each uncertainty value for each lattice point. The total number of lattice points is around 0.45 million.

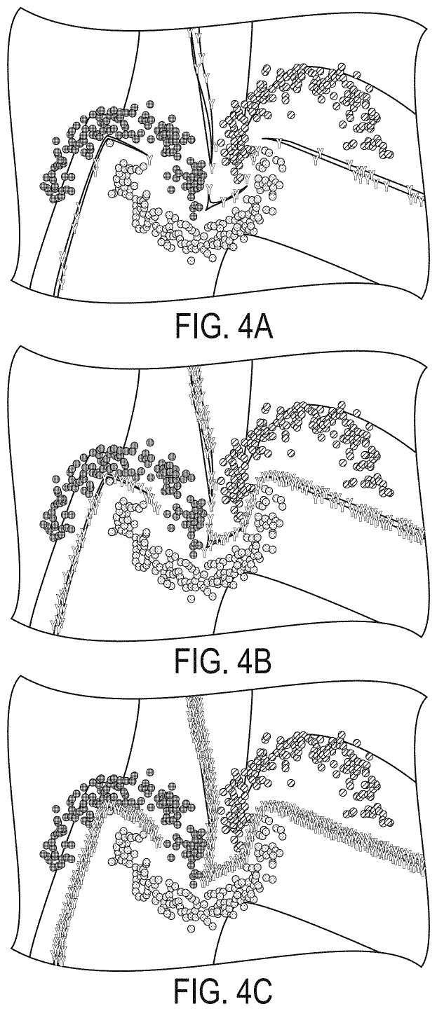

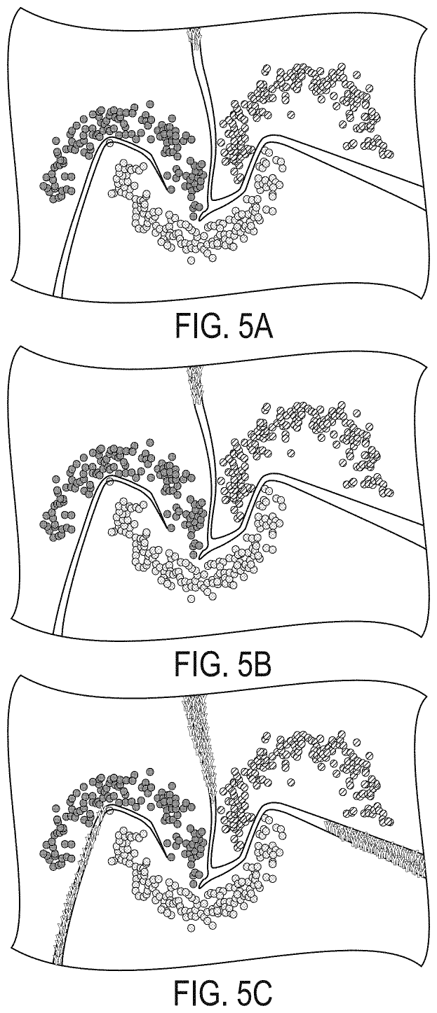

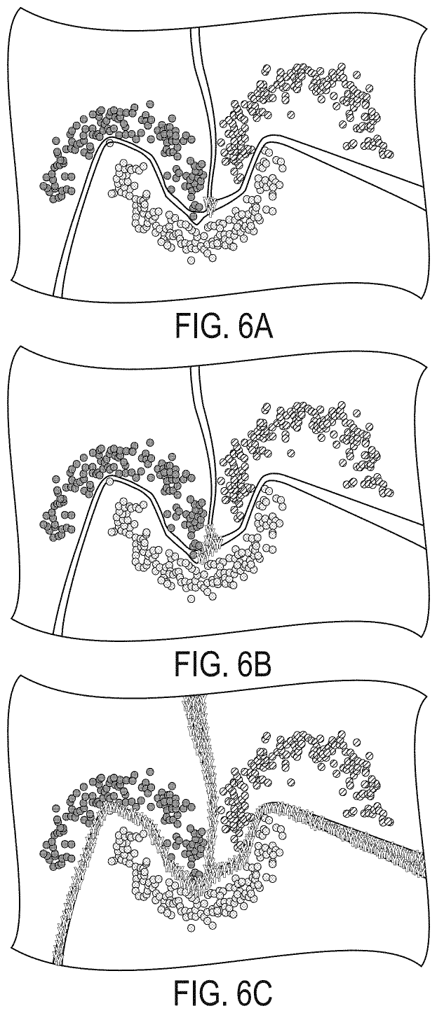

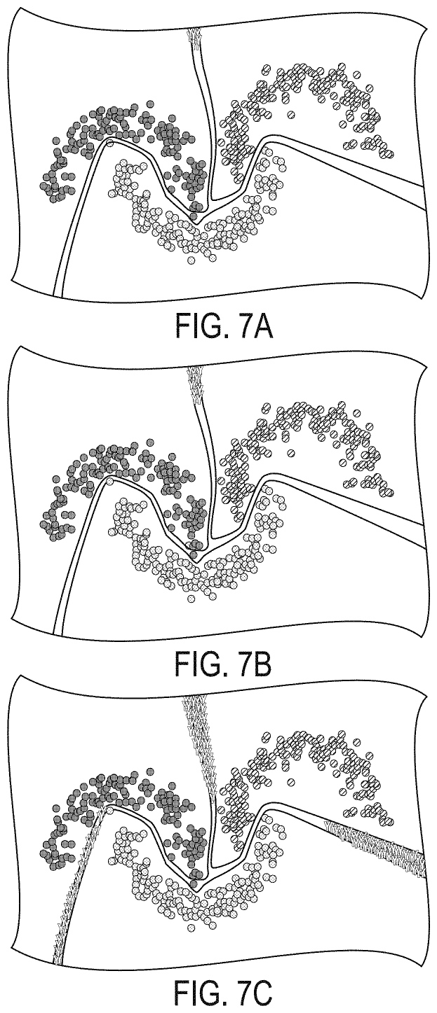

Then embodiments choose top-K high uncertainty values for each method to observe the prioritized region for each method. Embodiments use K=50, 250, 2500. FIGS. 4A, 4B and 4C illustrate the top-K points selected by BABA (see the points marked “Y”). Comparative examples are given for K=50, 250 and 2500 picking the top-K points. The points marked “Y” in FIGS. 5A, 5B, 5C, also 6A, 6B, 6C, and finally also see 7A, 7B, and 7C are comparative examples for picking top-K points. FIGS. 5A, 5B, and 5C are for a BALD acquisition measure. FIGS. 6A, 6B, and 6C are for an Entropy acquisition measure. FIGS. 7A, 7B, and 7C are for a MeanSD acquisition measure

A significant phenomenon is that BABA's selection is highly diversified along the decision boundary with a small number of selections.

In contrast, there is a preferred area for the methods of other measures (the comparative example algorithms), so highly concentrated around a specific region, high concentration of choices or picking many choices from similar values of unlabeled data is not as good for rapid learning.

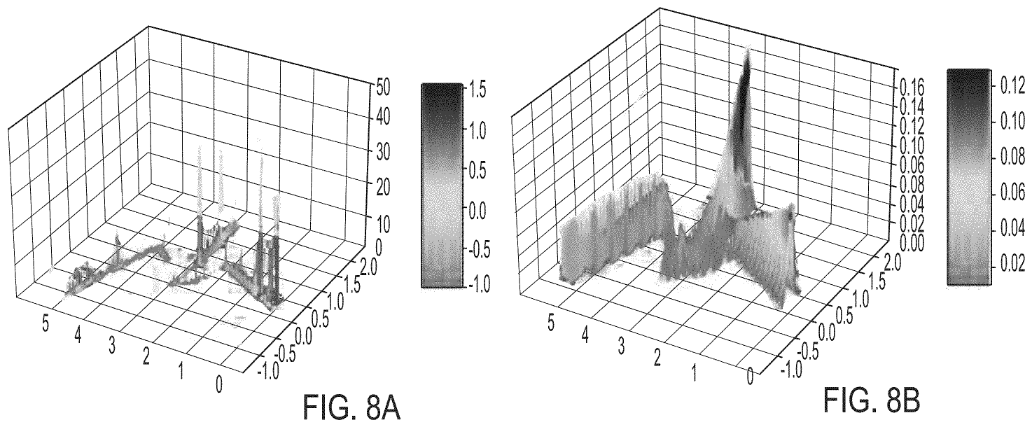

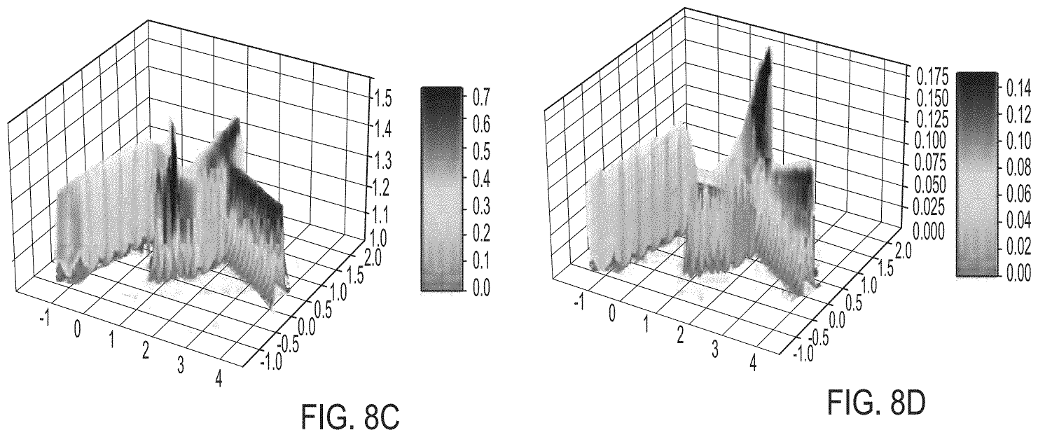

Finally, FIGS. 8A, 8B, 8C and 8D show 3D plots of uncertainty values generated by each method on the domain. All methods show high sensitivity along the decision boundary, but there is a biased direction preferred by each method except BABA. BABA values are highly sensitive to the decision boundary even within a small region. So a tiny perturbation of the area induces to make the BABA value (Eq. 12) change significantly. Because of this sensitivity, BABA provides a diversification effect along the decision boundary as illustrated in FIGS. 4A, 4B and 4C.

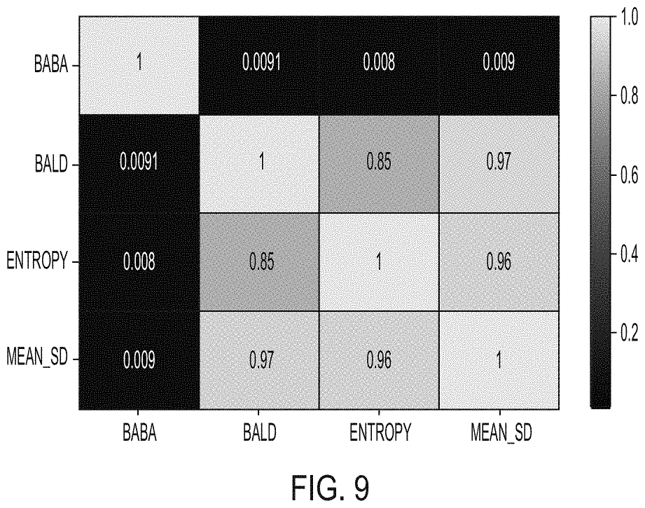

Also illustrated herein are results of calculating the empirical correlation matrix among all measures. FIG. 9 shows the correlation. BABA has almost zero correlation with other measures (the comparative example algorithms do not have the acquisition behavior as BABA) implying that the scoring mechanism of BABA is completely different from other methods.

Example pseudocode for implementation of BABA active learning is as follows.

BABA Pseudocode

The notation “\” in items 5 and 9 is the set minus operator.

Item 1. Input: 1) Unlabeled dataset Dₚₒₒₗ, 2) initially labelled data set D_{training}⁰, 3) the number of dropout samples M at inference time, 4) active learning budget K for each iteration, 5) total active learning budget K^{tot}.

Item 2. Initialize all weights of Bayesian neural network Φ and set←0.

Item 3. Repeat, for iteration n≥0 the following items up to the stopping condition given by the Until at Item 10.

Item 4. Train the model Φ with D_{training}ⁿ.

Item 5: for each x∈Dₚₒₒₗ\D_{training}ⁿ, perform Items 6, 7, 8.

Item 6. Generate M dropout samples (for example.

Item 7. Estimate Beta parameters (αᵢ,βᵢ) for each each marginal distribution using Eq. (4).

Item 8. Calculate the BABA ratio using Eq. (12).

Item 9. Set D_{training}ⁿ⁺¹←D_{training}ⁿ∪{top K BABA−valued x∈Dₚₒₒₗ\D_{training}ⁿ}, and n←n+1.

Item 10. Until |D_{training}ⁿ⁻¹| reaches K^{tot}.

Example values of M are 100 or 300.

In some embodiments, the implementation structure for the BABA active learning algorithm has similarities to other MC dropout-based uncertainty methods. A significant difference is the dropout samples at inference time, that is, BABA includes an additional estimation step of Beta parameters for each marginal distribution. The pseudocode above (“BABA Pseudocode”) explains the steps of the BABA active learning algorithm. As described above after the presentation of Eq. (11), the weight initialization of the model Φ is performed only at the beginning of training, in some embodiments. After the initialization, embodiments re-start from the previously trained model weights at each active learning iteration. Also, in some embodiments, an early stopping criteria is not applied during training because early stopping conflicts with dropout-based model training. Observations have been made in developing the BABA algorithm that stopping too early in model training (for example, by observing validation accuracy or loss) causes model weights of Φ to not correspond to fully mixed states of randomness (consider MC dropouts, and the early stage of Markov Chain Monte Carlo (MCMC)).

Experimental Results

Table 1, Table 2 and Table 3 below provide experimental results.

In recent years, significant efforts have been made on building an efficient framework of unsupervised or self-supervised feature learning such as SimCLR (Contrastive Learning of Visual Representations), MoCo, BYOL, and SwAV. Also, various neural network structures may be used. Below ResNet refers to a residual network. Residual neural networks utilize skip connections or shortcuts to jump over some layers.

As an application in active learning, embodiments leverage the feature space from the unsupervised feature learning without explicitly knowing true labels but construct a good representation space. In Table 1, results correspond to SimCLR with ResNet-50 to build a feature space for CIFAR-10 and CIFAR-100. Thus, the feature space is fixed. For example, in FIG. 1C, the weights of the neural network 1 (backbone) have been trained and are no longer updated. Meanwhile, the weights in neural network 2 (classifier model) are updated with unlabeled data selected for presentation to the oracle for labelling using the acquisition function in the first column of Table 1. In Table 1, the data is from CIFAR-10 (second column) and CIFAR-100 (third column).

TABLE 1

| Method | CIFAR-10 | CIFAR-100 |
|---|---|---|
| Random | 0 ± 0.75% | 0 ± 0.76% |
| BALD | 1.16 ± 0.35% | 0.09 ± 1.19% |
| Entropy | 1.07 ± 0.32% | −3.50 ± 1.18% |
| MeanSD | 1.01 ± 0.42% | −0.03 ± 0.66% |
| CoreGCN | 0.32 ± 0.53% | −2.06 ± 0.84% |
| CoreSet | −1.15 ± 0.35% | −2.72 ± 1.03% |
| UncertainGCN | −1.43 ± 0.53% | −5.66 ± 1.33% |
| BABA | 1.51 ± 0.45% | 2.70 ± 0.96% |

Table 1 provides relative accuracy with respect to random for CFAR-10 and for CIFAR-100. For both experiments, the acquisition size is 500.

In both datasets (CIFAR-10 and CIFAR-100), BABA outperforms all other baseline methods as shown in Table 1. In this fixed feature scenario, all other effects possibly affecting the model's performance have been removed, such as data augmentation or the role of backbone in the classification. Therefore, picking the data near the decision boundary could improve the accuracy in each active learning iteration. As demonstrated in FIGS. 4A, 4B and 4C, BABA is efficient in selecting diversified points along the decision boundary (see the points marked with a “Y”). Related to this selection of diversified points, BABA shows the best performance in Table 1.

In contrast, CoreSet, CoreGCN, and UncertainGCN suffer from improving accuracy because those methods mainly focus on diversification or without fully considering the information regarding the decision boundary given by the original training model. This information cannot be effectively captured by an auxiliary graph neural network for CoreGCN or UncertainGCN under the Bayesian neural network framework.

Pre-Trained Backbone and Heavy Data Augmentation

In this experiment, an important image classification scenario is followed as opposed to applying only a random flip without a pre-trained backbone. The ResNet-18 backbone is used with an ImageNet pre-trained model for model architecture, and the last linear classification layer is replaced with a simple MC dropout-based Bayesian neural network.

Then, after the pre-training, heavy data augmentations are applied to generate more data. These data augmentations include random crop, random flip, random color jitter, and random grayscale. Under this scenario, the feature space from the backbone is continuously evolving and the feature space is confused. The backbone adjusts and changes as the classifier, Φ, is updated. For example, an input data point is mapped to a different location in the feature space. That is, the backbone evolves as the training and active learning process proceeds. BABA tracks uncertainty and is focused on picking points associated with high uncertainty. Because of this dynamic, BABA follows a greedy perspective and chooses the point it finds to have high uncertainty at the current iteration. BABA has both the effect of choosing points near the decision boundary and choosing a variety of points (diversity).

In this somewhat degraded feature space, diversification within the feature is more important compared to the unsupervised feature scenario corresponding to Table 1 above. Because of the heavy data augmentation, the decision boundary keeps confused (is slow to converge to an ideal locus of points), and the information near the decision boundary is critical to improving the accuracy. Among the methods presented in Table 2, TA-VAAL (Task-aware variational adversarial active learning) is designed to select points with improved diversity and efficiency near the decision boundary. For the experiment of Table 2, neural network 1 (backbone, see FIG. 1C) continues to be trained while the classification model is trained.

TABLE 2

| Method | CIFAR-10 | CIFAR-100 | Caltech-256 |
|---|---|---|---|
| Random | 0 ± 0.49% | 0 ± 0.88% | 0 ± 0.83% |
| BALD | 0.59 ± 0.72% | 2.62 ± 1.07% | 2.61 ± 1.22% |
| Entropy | 0.19 ± 0.96% | 2.68 ± 1.19% | 2.59 ± 1.39% |
| MeanSD | 0.78 ± 0.84% | 3.03 ± 1.15% | 1.76 ± 1.32% |
| CoreGCN | 1.38 ± 0.67% | 2.79 ± 0.97% | 3.39 ± 1.35% |
| CoreSet | −0.95 ± 0.46% | 2.95 ± 1.00% | 1.05 ± 1.31% |
| UncertainGCN | 1.73 ± 0.53% | 3.31 ± 0.94% | 3.84 ± 1.01% |
| TA-VAAL | 1.22 ± 0.58% | 2.72 ± 0.81% | 4.56 ± 0.95% |
| BABA | 1.14 ± 0.82% | 3.68 ± 0.69% | 6.26 ± 1.30% |

Relative accuracy with respect to random for CIFAR-10, CIFAR-100, and Caltech-256. The acquisition size used to obtain the data in Table 2 is 500 for CIFAR-10, 2500 for CIFAR-100, and 1500 for Caltech-256.

In Table 2, all baseline methods show improved accuracy compared to Random. In CIFAR-10, UncertainGCN shows the best performance, but most methods show very similar accuracy values overall. For CIFAR-100 and Caltech-256, BABA shows the best performance. Diversification along the decision boundary in BABA provides data exploration because the representation space keeps evolving with the backbone training. Although TA-VAAL shows a fairly good performance in this scenario, it requires additional but much longer VAE training, making the entire active learning process slower than other methods even compared to additional training in UncertainGCN or CoreGCN. Representation space is another expression of the term feature space.

In Table 3, the effect of redundant information is demonstrated. For simplicity, we augment two more identical images in each unlabeled data pool. Each dataset contains exactly three identical images for each image in the pool. To remove other effects, the same unsupervised feature and the model architecture are used as in the experiment of Table 1. Table 3 compares how each method diversifies the selection under a redundant data pool scenario with a fixed feature space. For the experiment of Table 3, neural network 1 (backbone, see FIG. 1C) has completed training and the weights of the backbone are fixed during the training of the classification model.

TABLE 3

| Method | 3 × CIFAR-10 | 3 × CIFAR-100 |
|---|---|---|
| Random | 0 ± 0.59% | 0 ± 1.11% |
| BALD | −1.53 ± 0.55% | −6.35 ± 0.97% |
| Entropy | −2.40 ± 0.59% | −14.04 ± 1.78% |
| MeanSD | −1.04 ± 0.36% | −5.77 ± 1.07% |
| CoreGCN | 0.35 ± 0.47% | −0.24 ± 1.14% |
| CoreSet | −1.26 ± 0.37% | −2.09 ± 1.37% |
| UncertainGCN | −2.21 ± 0.77% | −6.74 ± 1.79% |
| BABA | 1.91 ± 0.50% | 1.72 ± 1.05% |

As Table 3 shows, most uncertainty-based methods fail to remove the redundancy since the identical image produces same or similar uncertainty values.

BABA has randomized but meaningful uncertainty values given identical images in Dₚₒₒₗ. This occurs because MC dropout estimates slightly different Beta parameters for each identical image. Then, as demonstrated in FIGS. 4A, 4B and 4C, the value of the BABA ratio (Eq. 12) is sensitive to a slight change of the parameters near the decision boundary. So the diversification along the decision boundary is adequate for BABA, although some redundant selections are likely to exist.

Referring to Table 3, UncertainGCN suffers from removing redundancy. And CoreSet and CoreGCN appear to remove the redundancy by diversifying the sample. Still, CoreSet and CoreGCN cannot fully take into account the uncertainty near the decision boundary as similarly observed in the experiment of Table 1.

Ablation Study

The effect of the BABA ratio with and without BALD has been checked as an ablation study. It has been found that including BALD (see Eq. (12)) in the BABA ratio is helpful to improve performance as the active learning iteration proceeds further (acquired data set size is large, for example, the size of D_training >10000). As the model assumes more information about the training dataset, the epistemic uncertainty (see Eq. (14)) is more important than the initial exploration stage of the active learning.

Effect of Different Prioritization in BABA

Below are defined two additional acquisition functions.

$$PositiveBABA [ x ] := \frac{M JEnt [ x ]}{BALD [ x ]} \qquad Eq . ( 15 )$$

$$NegativeBABA [ x ] := - \frac{M JEnt [ x ]}{BALD [ x ]} \qquad Eq . ( 16 )$$

PositiveBABA (Eq. (15)) has similar performance to BABA (Eq. 12) for the scenario of Table 1 with CIFAR-10 and with any of the data sets of Table 2. NegativeBABA (Eq. (16)) performs poorly in the scenario of Table 1 and performs moderately well in the scenario of Table 2 with CIFAR-100 and Caltech-256.

Overall, the performance of the two extreme directions PositiveBABA and NegativeBABA are worse than the case of the definition of BABA (Eq. (12)) when MJEnt[x]→0. The high confidence selection from the model when MJEnt[x]→−∞ typically does not improve the performance of the active learning. In a heavy data augmentation scenario, the high confidence selection shows a weaker performance. However, the high confidence selection can still moderately improve the performance as the data augmentation keeps evolving the decision boundary meaning that the model's confidence also keeps changing as the active learning iteration proceeds.

Some Parameter Values

The backbone network for Table 1 and Table 3 is ResNet-50. For Table 2, it is ResNet-18. The image size for Table 1 and Table 3 is 224×224; for Table 2, it is 32×32. The batch size is 128, the learning rate is 0.0003 and the optimizer is Adam for Tables 1, 2 and 3. The number of epochs for Table 1 and Table 3 is 300; for Table 2, it is 150. Additional description of the scenarios is provided in Table 4.

TABLE 4

| Scenario | Dataset | # Classes | K | K^{tot} |
|---|---|---|---|---|
| Table 1, | CIFAR-10 | 10 | 500 | 5000 |
| Unsupervised | CIFAR-100 | 100 | 500 | 5000 |
| feature learning. | | | | |
| Fixed backbone. | | | | |
| Table 2, | CIFAR-10 | 10 | 500 | 5000 |
| Pre-trained | CIFAR-100 | 100 | 2500 | 25000 |
| backbone, heavy | Caltech-256 | 256 | 1500 | 15000 |
| augmentation, | | | | |
| and evolving | | | | |
| backbone. | | | | |
| Table 3, | CIFAR-10 | 10 | 500 | 5000 |
| Redundant pool. | CIFAR-100 | 100 | 500 | 5000 |
| Fixed backbone. | | | | |

In each table above, the mean and the standard deviation of the relative accuracy are disclosed here with respect to the random method results. Let N be the number of repeated experiments. For each accumulated dataset size t and the random acquisition function R, denote by Ri(t) the accuracy for the random acquisition at the size t for the i-th experiment. Then embodiments compute the geometric mean of the series Ri(t) for each t. This is a baseline accuracy to compare with others.

$$G {M}_{R} ( t ) := exp ( \frac{1}{N} {\sum }_{i} log ( {R}_{i} ( t ) ) )$$

For each observed experiment series Si(t), embodiments compute the relative accuracy as follows:

$$RelAc {c}_{{s}_{i}} ( t ) := log ( \frac{{S}_{i} ( t )}{G {M}_{R} ( t )} )$$

Then for each method S∈{Rand, BALD, Entropy, MeanSD, CoreGCN, CoreSet, UncertainGCN}, the total mean and standard deviation of relative accuracies are given by writing Mean(S)+/−SD(S) obtained from

$$Mean ( S ) := \frac{1}{N T} {\sum }_{i , t} RelAc {c}_{{s}_{i}} ( t ) ,$$

$$SD ( S ) := \sqrt{\frac{1}{N T} {\sum }_{i , t}} ( {\vert {RelAcc}_{{s}_{i}} ( t ) \vert}^{2} - {\vert Mean ( S ) \vert}^{2} )$$

Where T is the number of all observed cumulative acquisition data-size points. Similarly, embodiments do the same calculations for the log-likelihood.

Example Structure

The active learning classifier engine, the model builder engine and/or the classification engine (see FIGS. 1A and 1B) may be an apparatus such as a server, a computer, a laptop computer, a handheld device, or a tablet computer device, for example.

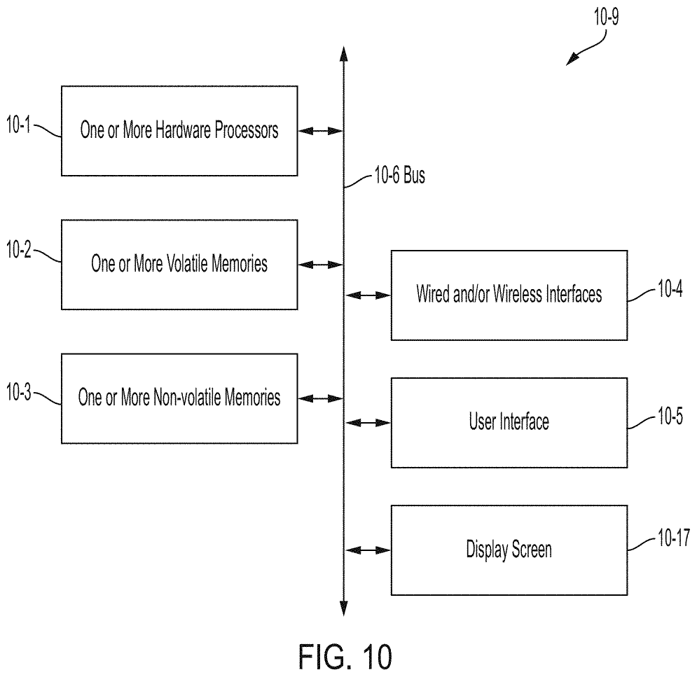

FIG. 10 illustrates an exemplary apparatus 10-9 for implementation of the embodiments disclosed herein. The apparatus 10-9 may be a server, a computer, a laptop computer, a handheld device, or a tablet computer device, for example. Apparatus 10-9 may include one or more hardware processors 10-1. The one or more hardware processors may include an ASIC (application specific integrated circuit), CPU (for example CISC or RISC device), and/or custom hardware and communicate with other items of apparatus 10-9 on a bus 10-6. Apparatus 10-9 also may include wired and/or wireless interfaces 10-4, a display screen 10-7, and a user interface 10-5 (for example an additional display screen and/or keyboard and/or pointing device such as a mouse). Apparatus 10-9 may include one or more volatile memories 10-2 and one or more non-volatile memories 10-3. The one or more non-volatile memories 10-3 may include a non-transitory computer readable medium storing instructions for execution by the one or more hardware processors 10-1 to cause apparatus 10-9 to perform any of the methods of embodiments disclosed herein.

### CONCLUSION

Provided herein is a new uncertainty measure, BABA, for Bayesian active learning by Beta approximation under an MC dropout regime. FIGS. 4A, 4B, 4C, 8A, 9 and Tables 1, 2 and 3 demonstrate the computational and accuracy advantages of the BABA algorithm (Eq. 12 and BABA Pseudocode). BABA offers a diversified selection and is a unique measure compared to other uncertainty measures. Also, BABA is not confined to active learning problems. BABA can be applied to improve the diversified selection process in a different type of Bayesian neural network framework such as Dirichlet approximation through model parameters.

At the same GPU environment, e.g. GTX 1080Ti with 11 Gb memory, with the acquisition size 20, embodiments observe that the computational time for BABA is about 10-times faster. Beta approximation has been made from heuristic observations by inspecting the marginal distribution of the predictive probability. The Beta approximation phenomenon is widely applicable.

The definition of the normalized mutual information provided in this application is a novel measure. This novel measure includes the absolute value to make the denominator non-negative, but the value range can be [0, +∞] instead of [0,1]. This infinite range phenomenon is closely related to the difference between the Shannon entropy and the differential entropy. This new kind of normalized mutual information has wide applicability in acquisition functions and in classification.

Experimental results demonstrate performance improvement over previous approaches (see FIGS. 3-6 and Tables 1-4). Embodiments, for the first time, demonstrate the applicability of the normalized mutual information under a deep Bayesian active learning framework.

What is claimed is:

1. An active learning classifier engine for classifying an observation under a label using machine learning, the active learning classifier engine comprising one or more processors executing instructions from one or more memories to implement:
a model builder engine configured to operate on a data set D_{training} and Dₚₒₒₗ and consult an oracle to produce a model after-convergence Φ; and
a classification engine configured to use the model after-convergence Φ to act on the observation to produce the label,
wherein the model builder engine is configured to:
identify, based on an entropy measure and an information measure, a training value x* for which a model-in-training Φ provides low information according to the entropy measure and the training value x* probably has some information about a correct classification Y* for x* according to the information measure,
provide x* to the oracle to obtain Y*, and
update the model-in-training with Y* to obtain the model after-convergence Φ, thereby reducing a training time of the active learning classifier engine to obtain the label.

2. The active learning classifier engine of claim 1, wherein the model builder engine is further configured to identify, based on the entropy measure and the information measure, the training value x* for which the model-in-training Φ provides first information below a first bit precision threshold according to the entropy measure and the training value x* is associated with second information above a second bit threshold about the correct classification Y* for x* according to the information measure.

3. The active learning classifier engine of claim 2, wherein the first bit threshold is 0.1 bits given precision of the first information per a ranked unlabeled data point and the second bit threshold is 0.1 bits per the ranked unlabeled data point.

4. The active learning classifier engine of claim 1, wherein the information measure is BALD.

5. The active learning classifier engine of claim 1, wherein the entropy measure is expressed as the following equation in which i ranges over a simplex of C classes, Pᵢ is an estimated probability of assigning a data point x to a class i, f(Pᵢ) is a density function and E_{P}_{ᵢ} is an expectation with respect to Pᵢ treated as a random variable:
MJEnt[x]=−ΣᵢE_{P}_{ᵢ}[Pᵢ log(Pᵢf(Pᵢ))]

6. The active learning classifier engine of claim 5, wherein f(Pᵢ) is a Beta distribution.

7. The active learning classifier engine of claim 1, wherein the model builder engine is further configured to identify the training value x* for which the model-in-training provides approximately zero information value and x* has some information about the correct classification, Y, and such data x* has some correlation or compatibility with previously-used training data.

8. The active learning classifier engine of claim 5, wherein the information measure is BALD, the model builder engine is further configured to identify, based on the entropy measure MJEnt[x] and BALD, the training value x* for which the model-in-training provides third information below a third bit threshold.

9. An active learning classifier engine for classifying an observation under a label using machine learning, the active learning classifier engine comprising:
one or more memories storing instructions; and
one or more processors configured to execute the instructions to implement:
a model builder engine configured to operate on a data set comprising D_{training} and Dₚₒₒₗ and consult an oracle to train a model-in-training and produce a model-after-convergence Φ, and
a classification engine configured to use the model-after-convergence Φ to act on the observation to produce the label,
wherein the model builder engine is further configured to:
A) sample a first plurality of data points from D_{training},
B) for a first data point in the first plurality of data points:
a) generate M dropout samples of estimated values y to form a plurality of estimated values y, wherein the estimated values y are samples of a domain of a simplex of classes,
b) calculate a plurality of model statistics of the plurality of estimated values y, wherein the plurality of model statistics includes a first α and a first β for a first estimated value y corresponding to a first class in the simplex of classes, and
c) calculate a first acquisition function measure for the first data point,
C) repeat a) through c) for each data point in the first plurality of data points, thereby forming a plurality of acquisition function measures corresponding, respectively, to each data point in the first plurality of data points,
D) rank the plurality of acquisition function measures,
E) identify a top K data points of the first plurality of data points as x*,
F) provide x* to the oracle to obtain Y*, and
G) update the model-in-training with Y* to obtain the model-after-convergence, thereby reducing a training time of the active learning classifier engine to obtain the label.

10. An active learning classifier engine for classifying an observation under a label using machine learning, the active learning classifier engine comprising one or more processors executing instructions from one or more memories to implement:
a model builder engine configured to operate on a data set D_{training} and Dₚₒₒₗ for N epochs and produce a model after-convergence Φ, wherein convergence corresponds to a classification accuracy measure exceeding an accuracy threshold; and
a classification engine configured to use the model after-convergence Φ to act on the observation to produce the label,
wherein the model builder engine is further configured to:
identify a tentative decision boundary between at least two classes,
evaluate uncertainty in a trial classification of a plurality of samples from Dₚₒₒₗ, wherein the plurality of samples are not in D_{training}, wherein the trial classification is based on a model-in-training,
determine, based on the uncertainty, a plurality of information values respectively corresponding to the plurality of samples,
select a second plurality of samples as a first number of top-ranked samples of the plurality of samples, wherein the second plurality of samples is approximately uniformly distributed along an extent of the tentative decision boundary and
update the model-in-training based on the second plurality of samples.

11. The active learning classifier engine of claim 10, wherein the model builder engine is further configured to obtain a plurality of labels for the second plurality of samples, respectively, before the model-in-training is updated.

12. The active learning classifier engine of claim 11, wherein the model builder engine is further configured to obtain the plurality of labels from an oracle.

13. The active learning classifier engine of claim 10, wherein the first number of top-ranked samples is 50.

14. The active learning classifier engine of claim 10, wherein the first number of top-ranked samples is 250.

15. The active learning classifier engine of claim 10, wherein the first number of top-ranked samples is more than about 50 and the first number of top-ranked samples is not more than about 1000.

16. The active learning classifier engine of claim 10, wherein the N epochs correspond to 100 epochs or less.

17. The active learning classifier engine of claim 10, wherein the accuracy threshold corresponds to 0.9 or better precision score on a benchmark data set.

18. The active learning classifier engine of claim 10, wherein the accuracy threshold corresponds to 0.9 or better recall score on a benchmark data set.

19. The active learning classifier engine of claim 17, wherein the benchmark data set is CIFAR-10, CIFAR-100, or Caltech-256.

20. The active learning classifier engine of claim 18, wherein the benchmark data set is CIFAR-10, CIFAR-100, or Caltech-256.
